(19) United States
(12) Patent Application Publication
(10) Pub. No.: US 2016/0190817 A1
(43) Pub. Date: Jun. 30, 2016

(54) WIRELESS POWER TRANSFER BAG FOR MOBILE DEVICES

(71) Applicants: Jeremy Hartelt, Daly City, CA (US); Kyle Hartelt, Portland, OR (US); Dave Boyer, San Francisco, CA (US)

(72) Inventors: Jeremy Hartelt, Daly City, CA (US); Kyle Hartelt, Portland, OR (US); Dave Boyer, San Francisco, CA (US)

(21) Appl. No.: 14/869,612

(22) Filed: Sep. 29, 2015

Related U.S. Application Data
(60) Provisional application No. 62/057,795, filed on Sep. 30, 2014.

(51) Int. Cl. H02J 5/00; H02J 50/90; H02J 7/02

(52) U.S. Cl. CPC H02J 5/005; H02J 7/025; H02J 50/90

(57) ABSTRACT

A bag may provide wireless power transfer to a mobile device located in the bag or in proximity to the bag. In some instances, the bag includes a backpack, luggage, or other bag to carry the mobile device and/or other items. The bag may include a power supply that may be wirelessly charged when the bag is placed in proximity to a wireless charging base. The power supply may be connected to a wireless power transmitter, which may wirelessly charge the mobile device located in the bag or within proximity to the bag.

### RELATED APPLICATIONS

This application claims the benefit of U.S. Provisional Application No. 62/057,795, filed Sep. 30, 2014, the entire contents of which are incorporated herein by reference.

### BACKGROUND

Many individuals use mobile devices with batteries and/or other items to power the mobile devices. In many instances while using a mobile device, an individual may desire to charge the mobile device (e.g., due to the mobile device having a threshold low level of battery power). In such instances, it is often inconvenient to plug the mobile device into an electrical outlet to charge the mobile device. Further, the individual may be located in an area in which no electrical outlet exists.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example bag to provide wireless power transfer to a mobile device.

FIG. 2 illustrates further example details of the bag of FIG. 1.

FIG. 3 illustrates an example bag where a wireless charging base positions the bag in an upright position to wireless transfer power.

### DETAILED DESCRIPTION

This disclosure describes a bag for wireless power transfer to a mobile device located in the bag or in proximity to the bag (e.g., within a particular distance). In some instances, the bag includes a backpack, luggage, or other bag to carry the mobile device and/or other items. The bag may include a power supply (e.g., battery) that may be wirelessly charged when the bag is placed in proximity to a wireless charging base that is external to the bag. The bag may be removed from the wireless charging base and provide portable power to the mobile device located in the bag or within proximity to the bag. The mobile device may be charged in a portable manner as the bag is moved to various environments. As such, the bag may be wirelessly charged without removing a power supply from the bag. Further, the bag may wirelessly charge any number of mobile devices in the bag without using cords to the mobile devices.

In many instances, the bag includes a wireless charging receiver to receive wireless power from the wireless charging base. The wireless charging receiver may generally be placed in the bag toward an exterior surface of the bag, such as in close proximity to an exterior material of the bag. The wireless charging receiver may be positioned in a bottom of the bag, toward a back of the bag (e.g., in a lower back portion of a bag where padding is provided), on a side of the bag, in a handle or strap of the bag, and so on. To charge the bag, the bag may be positioned on or in proximity to the wireless charging base so that the wireless charging receiver is aligned to the wireless charging base. The wireless charging base may be connected to an external power source, such as an electrical power outlet/socket. In some instances, the wireless charging base may support the bag so that the bag is maintained in a particular position and/or so that the wireless charging receiver is positioned in proximity to the wireless charging base. In one example, the wireless charging base may slide into a compartment on a lower portion of the bag to hold the bag in an upright (vertical) orientation. The compartment may include the wireless charging receiver so that the wireless charging base is aligned properly. In another example, the wireless charging base may be part of a hook or other device that secures the bag on a wall. Here, the wireless charging receiver may be located in a handle or strap of the bag that is placed on the hook.

Power may be wirelessly transferred from the wireless charging base to the wireless charging receiver of the bag and stored in the power supply of the bag (e.g., power supply unit). The wireless charging receiver in the bag may be connected to the power supply of the bag via a wire or other connection. The power supply may include a battery or any other portable power supply that may store power. In one example, the power supply comprises a rechargeable battery. A battery may include a lithium ion battery, zinc-carbon battery, alkaline battery, lead-acid battery, and so on. The power supply may be positioned in any location in the bag.

The power supply of the bag may be connected to a wireless power transmitter (sometimes referred to as “device charging system”) that is configured to provide wireless power (e.g., inductance power) to a mobile device located in the bag. That is, the wireless power transmitter may charge the mobile device wirelessly. The wireless power transmitter may be located in or within proximity to a compartment of the bag this is used to store the mobile device, such as a pocket or other storage compartment. In one example, the wireless power transmitter forms part of a compartment that is distal to a back portion of the bag (e.g., distal to a portion of a backpack that is attached to a user's back). In another example, the wireless power transmitter is located in a strap of the bag, so that a mobile device that is stored in the strap may be charged. Alternatively, or additionally, the wireless power transmitter may be located in proximity to an exterior surface of the bag. This may allow a mobile device that is, for example, resting on a table to be charged by laying the bag on top of the mobile device so that the wireless power transmitter is positioned over the mobile device. Further, in some instances the bag may include multiple wireless power transmitters for different compartments of the bag. Each compartment may be sized, shaped, or otherwise adapted to a particular type of mobile device. To illustrate, the bag may include a relatively small compartment along a side of the bag to charge a smart phone and may include a relatively large compartment in a center of the bag to charge a laptop or tablet computer.

In one illustration of a bag with wireless power transfer functionality, the bag includes a wireless charging receiver located in a bottom of the bag. The wireless charging receiver is protected with foam, plastic, metal, or other materials. Here, the bag may be charged by placing the bag on a wireless charging base. In another illustration, a bag includes a wireless charging receiver that is located in a back portion of the bag. In this illustration, the wireless charging receiver is protected by padding that is located on the back portion of the bag (e.g., padding for the user's back). Here, the bag includes a pocket between the padding for the user's back and the wireless charging receiver. The pocket may slide onto a wireless charging base to charge the bag and hold the bag in an upright position. However, in some instances the pocket may not be included and the wireless charging base may otherwise attach to the bag to hold the bag upright (e.g., Velcro, snaps, or other securing devices).

Although the wireless charging receiver, the power supply, and the wireless power transmitter have been described as separate components, any number of these components may be implemented as a single component. Further, although the bag is described as including one or more wireless power transmitters, the bag may alternatively, or additionally, include a power cord to connect the power supply of the bag to a mobile device located within the bag or external to the bag. In addition, in some instances the bag may include a solar panel, a device that captures energy created from natural motion, and/or another device to charge the power supply of the bag. This may be used instead of (or in addition to) the wireless charging base. Moreover, the bag may include, in some instances, an input port to charge the power supply of the bag (e.g., to connect to an outlet) and/or an output port to connect to a mobile device (that is external/internal to the bag) to the power supply.

Wireless power transfer may be implemented with a variety of techniques, such as inductance power transfer and so on. Inductance power transfer may be implemented with an induction coil in a supply unit and an induction coil in a receiver. The induction coil in the supply unit may induce an electrical current in the induction coil of the receiver when the supply unit is positioned in close proximity to the receiver (e.g., within a particular distance). In some instance, wireless power transfer is referred to as inductance power transfer or electromagnetic induction. To illustrate wireless power transfer, a wireless charging base may include an induction coil to induce a current in an induction coil of a wireless charging receiver. In another illustration, a wireless power transmitter may include an induction coil to induce a current in an induction coil of a mobile device.

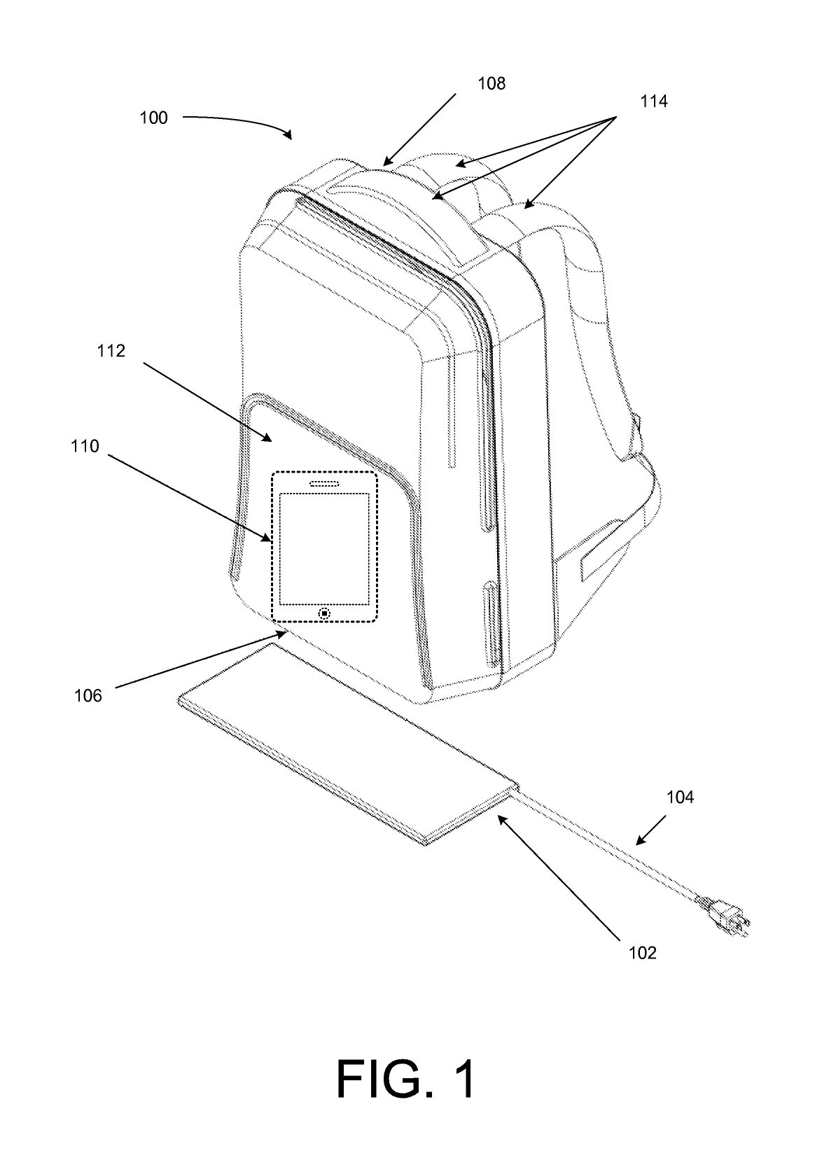

FIG. 1 illustrates an example bag 100 to provide wireless power transfer to a mobile device. The bag 100 may include a wireless charging receiver to receive power wirelessly from a wireless charging base 102. The wireless charging base 102 may include a cable 104 (e.g., power chord) to connect the wireless charging base 104 to an electrical outlet. In this example, the wireless charging receiver is located in a bottom portion 106 of the bag 100, which is opposite to a top portion 108 of the bag 100. Although in other examples, the wireless charging receiver may be located elsewhere within the bag 100 and/or be otherwise attached to the bag 100. The wireless charging receiver may be connected to a power supply, such as a rechargeable battery. The power supply may be connected to a wireless power transmitter that provides wireless power to a mobile device 110 located within the bag 100 and/or within proximity to the bag 100 (e.g., within a predetermined range that is necessary for transferring power via inductance). The bag 100 may include an enclosure (as illustrated) to house the wireless charging receiver, the power supply, and/or the wireless power transmitter. The enclosure may include any type of material and/or components to protect components therein. In some instances, the wireless charging receiver, the power supply, and/or the wireless power transmitter are located in separate compartments in the bag 100. While in other instances, any number of these components may be secured in the same compartment.

In this example, the bag 100 includes a compartment 112 located on a front portion of the bag 100 to secure the mobile device 110. The compartment 112 (as well as any other compartments described herein) may include any number of securing elements to secure items, such as Velcro, straps, cords, zippers, rubber, and so on. Further, the compartment 112 (and any other compartment) may include protective elements, such as foam, plastic, or other materials to protect items therein (e.g., the mobile device 110). As illustrated, the bag 100 also includes straps 114 to assist a user in carrying the bag 100. In some instances, the straps 114 may include the wireless charging receiver, the power supply, and/or the wireless power transmitter. Further, the straps 114 may alternatively, or additionally, include a compartment to secure a mobile device.

In some instances, the wireless charging receiver, the power supply, and/or the wireless power transmitter are connected to each other via a control unit. The control unit may act as an intermediate element between the components. The control unit may control power transfer to and/or from the power supply. In some instances, the control unit may monitor levels of the power supply to determine when additional power is needed (e.g., determine that a battery has reached a threshold lower limit and needs to be charged). In some instances, the control unit is integral with the wireless charging receiver, the power supply, and/or the wireless power transmitter. While in other instances, the control unit is a separate element located anywhere within the bag 100. The control unit may include any variety of hardware and/or software to control the wireless charging receiver, the power supply, and/or the wireless power transmitter. In some instances, the control unit may include one or more processors configured to execute one or more software modules to perform various operations. The one or more processors may include a central processing unit (CPU), a graphics processing unit (GPU), a microprocessor, a digital signal processor, and so on. In other instances, any or all of the functions may be implemented (e.g., performed) in whole or in part by hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), etc.

In some instances, wireless power transfer may be facilitated by one or more processes. For example, the control unit may perform operations to cause power to be transferred from the wireless charging base 102 to the wireless charging receiver of the bag 100, from the wireless charging receiver to the power supply, from the power supply to the wireless power transmitter, and/or from the wireless power transmitter to the mobile device 110. The one or more processes (as well as each process described herein) may be represented as a logical flow graph, each operation of which represents a sequence of operations that can be implemented in hardware, software, or a combination thereof. In the context of software, the operations may represent computer-readable instructions stored on one or more computer-readable storage media that, when executed by one or more processors, perform the recited operations. Generally, computer-readable instructions include routines, programs, objects, components, data structures, and the like that perform particular functions or implement particular abstract data types. The operations may be performed in any order, and any number of the operations can be combined in any order and/or in parallel to implement the process. Further, any number of the operations may be omitted.

The mobile device 110 may comprise any type of computing device, such as a laptop computer, a desktop computer, a smart phone, an electronic reader device, a mobile handset, a personal digital assistant (PDA), a portable navigation device, a portable gaming device, a tablet computer, a watch, a portable media player, a wearable computing device (e.g., a watch, an optical head-mounted display (OHMD), a contact lens with computing capabilities, etc.), a television, a set-top box, an appliance, a camera, a robot, a hologram system, a security system, a thermostat, a smoke detector, an intercom, a home media system, a projector, and so on.

The mobile device 110 may be equipped with one or more processors, memory, and/or one or more network interfaces. The mobile device 110 may also include one or more cameras, one or more displays, one or more microphones, one or more speakers, one or more sensors, and/or one or more wireless charging receivers. These components may be communicatively coupled to the one or more processors. The one or more processors may include a central processing unit (CPU), a graphics processing unit (GPU), a microprocessor, a digital signal processor, and so on. The one or more cameras may include a front facing camera and/or a rear facing camera. The one or more displays may include a touch screen, a Liquid-crystal Display (LCD), a Light-emitting Diode (LED) display, an organic LED display, a plasma display, an electronic paper display, or any other type of technology. The one or more sensors may include an accelerometer, compass, gyroscope, magnetometer, Global Positioning System (GPS), olfactory sensor (e.g., for smell), or other sensor. The one or more wireless charging receivers of the mobile device 110 may include an induction coil and/or other components.

The memory of the mobile device 110 (as well as all other memory described herein) may include one or a combination of computer storage media (computer-readable media). Computer storage media includes volatile and non-volatile, removable and non-removable media implemented in any method or technology for storage of information, such as computer readable instructions, data structures, program modules, or other data. Computer storage media includes, but is not limited to, phase change memory (PRAM), static random-access memory (SRAM), dynamic random-access memory (DRAM), other types of random access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transitory medium that can be used to store information for access by a computing device. As defined herein, computer storage media does not include communication media, such as modulated data signals and carrier waves. As such, computer storage media is non-transitory media.

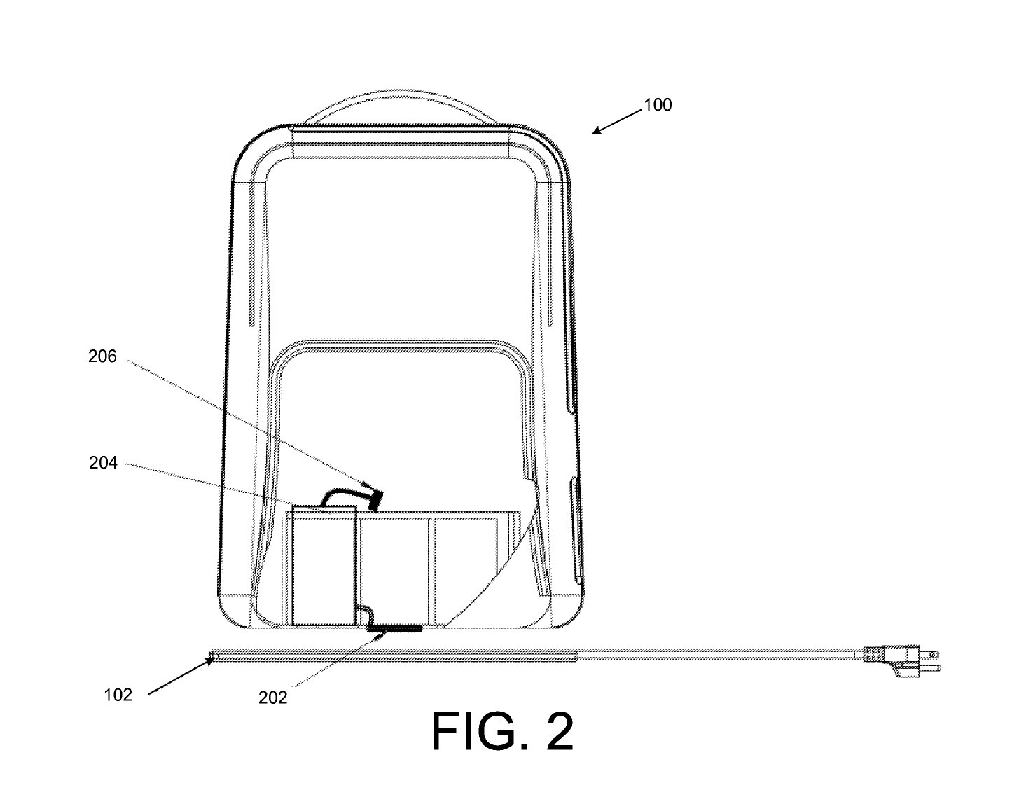

FIG. 2 illustrates further example details of the bag 100 of FIG. 1. As illustrated, the bag 100 includes a wireless charging receiver 202 configured to wireless receive power from the wireless charging base 102 when the wireless charging receiver 202 and the wireless charging base 102 are aligned (e.g., an induction coil in the wireless charging base 102 is aligned with (and within proximity to) an induction coil of the wireless charging receiver 202). The wireless charging receiver 202 may be connected to a power supply 204, such as a battery. Although a single power supply is illustrated, any number of power supplies may be provided, such as one in each of the three illustrated compartments in the lower portion of the bag 100. The power supply 204 may be connected to a wireless power transmitter 206 configure to wirelessly transfer power to a mobile device located in the bag 100 (or within proximity).

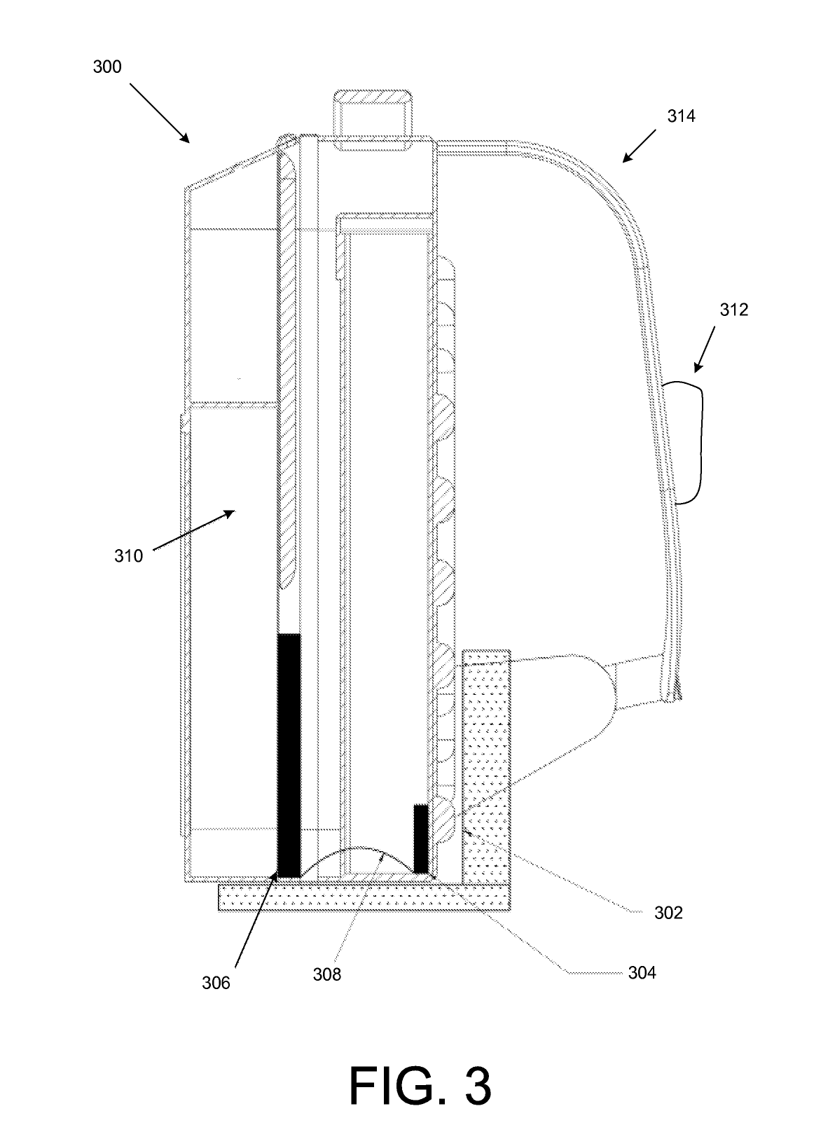

FIG. 3 illustrates an example bag 300 where a wireless charging base 302 positions the bag 300 in an upright position to wirelessly transfer power. As illustrated, the wireless charging base 302 may include an upright portion that extends in a vertical direction in FIG. 3 and a lower portion that extends in a vertical direction in FIG. 3. The upright portion may help secure the bag 300 to the wireless charging base 302. Although not illustrated, the wireless charging base 302 may be removably received within the bag 300 (e.g., within a compartment of the bag, such as a compartment between back padding on the bag 300 and a main portion of the bag 300 where items are stored).

Upon placing the bag 300 on the wireless charging base 302, power may be wirelessly transferred to a wireless charging receiver 304 located in the bag 302. The wireless charging receiver 304 may be connected to a power supply 306 via an electrical connection 308, such as a wire, cable, etc. The wireless charging receiver 304 may be located in a separate compartment than the power supply 306. The power supply 306 may be connected to a wireless power transmitter (not illustrated) to provide wireless power to a mobile device located in a compartment 310. Additionally, or alternatively, the bag 300 may include a compartment 312 located on a strap 314 to store another mobile device (e.g., a cell phone). Although not illustrated, a cable may connect the power supply 306 to a wireless power transmitter disposed in and/or within proximity to the compartment 312. For example, the cable may run along an interior portion of the bag 300 and through the strap 314 to the compartment 312. In one example, a smart phone may be placed in the compartment 312 and wirelessly charged. In another example, a wearable computing device, such as a watch, may be strapped around the strap 314 at a particular location and wirelessly charged.

In some instances, a bag as described herein may be manufactured and/or assembled. For example, a bag may be manufactured and/or assembled to include (i) a wireless charging receiver to receive wireless power from a wireless charging base, (ii) a power supply connected to the wireless charging receiver and configured to store energy, and/or (iii) a wireless power transmitter connected to the power supply.

Although embodiments have been described in language specific to structural features and/or methodological acts, it is to be understood that the disclosure is not necessarily limited to the specific features or acts described. Rather, the specific features and acts are disclosed herein as illustrative forms of implementing the embodiments.

What is claim is:

1. A bag comprising:
an enclosure;
a wireless charging receiver disposed in the enclosure and configured to receive wireless power from a wireless charging base when the bag is located within a predetermined proximity to the wireless charging base;
a power supply disposed in the enclosure and connected to the wireless charging receiver, the power supply being configured to store energy; and
a wireless power transmitter disposed in the enclosure and connected to the power supply, the wireless power transmitter being configured to provide wireless power to a mobile device located within the bag and/or within a particular distance to the bag.

2. The bag of claim 1, wherein the wireless charging receiver is disposed in a bottom portion of the bag or a back portion of the bag.

3. The bag of claim 1, wherein the wireless power transmitter is located within a strap of the bag, the wireless power transmitter being configured to provide power to the mobile device when the mobile device is located within the strap of the bag.

4. The bag of claim 1, wherein the enclosure includes a compartment, the wireless power transmitter being located within the compartment and being configured to provide power to the mobile device when the mobile device is located within the compartment.

5. The bag of claim 1, wherein the power supply comprises a rechargeable battery.

6. The bag of claim 1, further comprising:
a compartment disposed in the enclosure, the compartment to removably receive the wireless charging base and maintain the bag in a particular orientation.

7. The bag of claim 1, wherein the wireless charging receiver is located in at least one of a strap of the bag or a handle of the bag.

8. The bag of claim 1, further comprising:
a first compartment disposed in the enclosure, the first compartment to secure the wireless power transmitter; and
a second compartment located adjacent to the first compartment, the second compartment to secure the mobile device so that an induction coil within the mobile device is oriented to receive power from the wireless power transmitter secured in the first compartment.

9. A system comprising:
a wireless charging base; and
a bag having (i) a wireless charging receiver to receive wireless power from the wireless charging base, (ii) a power supply connected to the wireless charging receiver and configured to store energy, and (iii) a wireless power transmitter connected to the power supply and configured to provide wireless power to a mobile device located within the bag and/or within a particular distance to the bag.

10. The system of claim 9, wherein:
the wireless charging receiver includes an induction coil; and
the wireless charging base includes (i) a cable to connect to an electrical outlet and (ii) an induction coil to induce a current in the induction coil of the wireless charging receiver.

11. The system of claim 10, wherein:
the wireless charging base includes a hook, the induction coil of the wireless charging base being disposed in the hook; and
the bag includes a strap to removably attach to the hook, the induction coil of the wireless charging receiver being disposed in the strap.

12. The system of claim 9, wherein the bag includes a strap to removably receive the mobile device, the wireless power transmitter being disposed in the strap.

13. The system of claim 9, wherein the wireless power transmitter includes an induction coil to induce current in an induction coil of the mobile device.

14. The system of claim 9, wherein the mobile device comprises at least one of a smart phone, a tablet computer, or a wearable computing device.

15. A bag comprising:
a wireless charging receiver configured to receive wireless power from a wireless charging base;
a first compartment to secure a power supply that is connected to the wireless charging receiver;
a second compartment to secure a wireless power transmitter that is connected to the power supply, the wireless power transmitter to provide wireless power to a mobile device; and
a third compartment to secure the mobile device, the third compartment being located adjacent to the second compartment.

16. The bag of claim 15, wherein the second compartment is located in a strap of the bag and the third compartment is attached to the strap.

17. The bag of claim 16, wherein the mobile device comprises at least one of a wearable computing device or a smart phone.

18. The bag of claim 16, further comprising:
a cable to connect the power supply to the wireless power transmitter.

19. The bag of claim 15, wherein the power supply comprises a rechargeable battery.

20. The bag of claim 15, wherein the wireless charging receiver is disposed in a bottom portion of the bag or a back portion of the bag.
